(19) United States
(12) Patent Application Publication
(10) Pub. No.: US 2016/0069759 A1
(43) Pub. Date: Mar. 10, 2016

(54) INERTIA MOMENTUM MEASUREMENT METHOD FOR ENGINE AND FRICTION LOSS MEASUREMENT METHOD FOR ENGINE

(71) Applicant: Taizo SHIMADA, Kanagawa (JP)

(72) Inventors: Taizo SHIMADA, Yokohama-shi (JP); Koji KOREMATSU, Inagi-shi (JP); Tadashi KUSHIYAMA, Tokyo (JP); Shinji YASUEDA, Yokosuka-shi (JP)

(73) Assignee: Taizo SHIMADA, Kanagawa (JP)

(21) Appl. No.: 14/844,083

(22) Filed: Sep. 3, 2015

(30) Foreign Application Priority Data
Sep. 8, 2014 (JP) 2014-182280

(51) Int. Cl. G01L 3/24; G01M 15/04

(52) U.S. Cl. CPC G01L 3/24; G01M 15/044

(57) ABSTRACT

An inertia momentum measurement method for an engine, the method including: a first step for measuring a deceleration dωe₁/dt of engine output rotation at the time of reduction to a first fuel supply amount which is less than a predetermined fuel supply amount, a second step for measuring a deceleration dωe₂/dt of engine output rotation at the time of reduction to a second fuel supply amount which is less than the predetermined fuel supply amount, and a third step for determining the total inertia momentum It on the basis of the following Expression (1):

It=(−ΔTe₂+ΔTe₁)/(dωe/dt−dωe₁/dt) (1)

where ΔTe₁ is an engine driving torque of the engine corresponding to the first fuel supply amount; and ΔTe₂ is an engine driving torque of the engine corresponding to the second fuel supply amount.

### RELATED APPLICATIONS

This invention claims the benefit of Japanese Patent Application No. 2014-182280 which is hereby incorporated by reference.

### TECHNICAL FIELD

The present invention relates to an inertia momentum measurement method for an engine and a friction loss measurement method for an engine using a deceleration method.

### TECHNICAL BACKGROUND

An engine configured to burn fuel inside a cylinder space, thereby causing a piston to move reciprocatingly, and to output power by converting the reciprocating movement into rotational movement is a well-known example of engines outputting power by burning fuel. For example, Japanese Laid-Open Patent Publication No. 2011-32976 (A) discloses a diesel engine 1 configured such that fuel is supplied to high-temperature air compressed in a combustion chamber of a cylinder 2, thereby causing auto-ignition, and a piston 3 located inside the cylinder 2 is pushed out by expansion resulting from the ignition. With such an engine, various types of energy loss such as exhaust loss (heat of exhaust gas), cooling loss (heat radiation to a cooling medium), and friction loss (including mechanical loss and pump loss) occur when the fuel is burned to operate the engine. Therefore, the remaining energy obtained by subtracting those types of energy loss from the energy produced by fuel combustion is taken out as power.

For this reason, by decreasing those various types of energy loss, it is possible to increase accordingly the energy output as power, thereby increasing engine efficiency. Where the reduction of those types of energy loss is investigated, it is of primary importance to measure those losses accurately. A deceleration method by which fuel combustion inside a cylinder space is stopped to cause engine deceleration, the inertia momentum of the engine is measured on the basis of the degree of deceleration, and a friction loss is measured by using the inertia momentum is known as one of the methods for measuring friction loss from among those types of losses.

In the deceleration method, the power of the engine which is the measurement object is typically output to a dynamometer, deceleration is caused by applying a predetermined load with the dynamometer, and the inertia momentum and friction loss are measured. In this case, the dynamometer is most often installed at the measurement facility. The resultant problem is that where the friction loss is to be measured by the conventional deceleration method, the inertia momentum and friction loss can be measured only at the measurement facility at which the dynamometer has been installed.

### SUMMARY OF THE INVENTION

The present invention has been created with consideration for this problem, and it is an objective of the present invention to provide a method for measuring an inertia momentum of an engine and a method for measuring a friction loss of an engine that makes it possible to measure the inertia momentum and friction loss without using the measurement facility at which the dynamometer has been installed.

The inertia momentum measurement method for an engine in accordance with the present invention is a method for measuring a total inertia momentum It of an engine in a state in which a drive device which is driven by the engine is connected to an output shaft of the engine, the engine including a driving system of the drive device, the method including a first step for measuring a deceleration dωe₁/dt of engine output rotation when a fuel supply amount to the engine is reduced to a first fuel supply amount, which is less than a predetermined fuel supply amount, from a state in which the predetermined fuel supply is performed to the engine and the engine is steadily operated to drive the drive device; a second step for measuring a deceleration dωe₂/dt of engine output rotation when a fuel supply amount to the engine is reduced to a second fuel supply amount, which is less than the predetermined fuel supply amount, from a state in which the predetermined fuel supply is performed to the engine and the engine is steadily operated in the same manner as in the aforementioned steady operation to drive the drive device; and a third step for determining the total inertia momentum It on the basis of the following Expression (1):

It=(−ΔTe₂+ΔTe₁)/(dωe/dt−dωe₁/dt) (1)

where ΔTe₁ is an engine driving torque of the engine corresponding to the first fuel supply amount; and ΔTe₂ is an engine driving torque of the engine corresponding to the second fuel supply amount.

In the above-described inertia momentum measurement method for an engine, it is preferred that the engine driving torque ΔTe₁ and the engine driving torque ΔTe₂ be determined on the basis of a proportional relationship between the fuel supply amount to the engine and the engine driving torque.

Further, in the above-described inertia momentum measurement method for an engine, it is preferred that in the first step, the deceleration dωe₁/dt of the engine output rotation be measured by taking the first fuel supply amount as zero and the total inertia momentum It be determined on the basis of the following Expression (2):

It=−ΔTe₂/(dωe₂/dt−dωe₁/dt) (2).

A friction loss measurement method for an engine in accordance with the present invention includes: a fourth step for determining the total inertia momentum It by the above-described method; a fifth step for measuring a deceleration dω/dt of engine output rotation when a fuel supply amount to the engine is cut off from a state in which the engine is operated to drive the drive device; and a sixth step for determining a total friction torque Tt for the engine including the drive device on the basis of the following Expression (3):

Tt=It×6ω/dt (3).

The inertia momentum measurement method for an engine in accordance with the present invention includes a first step for measuring a deceleration dωe₁/dt of the engine output rotation at the time of reduction to a first fuel supply amount which is less than a predetermined fuel supply amount, a second step for measuring a deceleration dωe₂/dt of the engine output rotation at the time of reduction to a second fuel supply amount which is less than the predetermined fuel supply amount, and a third step for determining the total inertia momentum It on the basis of Expression (1) above. In Expression (1), the deceleration dωe₁/dt and deceleration dωe₂/dt are determined by measurements, and therefore the engine driving torque Te₂ at the time of the first fuel supply amount and the engine driving torque Te₂ at the time of the second fuel supply amount are determined, for example, by finding in advance the relationship between the fuel supply amount and engine driving torque. Thus, where Expression (1) is used, it is not necessary to apply a torque serving as a resistance for obtaining the deceleration state, while performing measurements by using a dynamometer. Therefore, the inertia momentum can be measured directly, for example, at the engine installed at a working machine, or the like, outside of the measurement facility provided with a dynamometer.

Further, with the friction loss measurement method for an engine in accordance with the present invention, by using the total inertia momentum of the engine which is determined in the above-described manner, it is possible to measure in a simple manner the total friction torque Tt of the engine by measuring the deceleration dωe/dt when the fuel supply amount to the engine is cut off in a state in which the engine is installed on a working machine, or the like. Thus, the occurrence of, for example, engine performance degradation and failure can be accurately predicted in advance by measuring in a simple manner the total friction torque Tt in a state in which the engine is installed on a working machine, or the like, without the necessity to use a dynamometer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 illustrates the schematic configuration of a diesel engine as an example of application of the present invention;

FIGS. 2A and 2B are explanatory drawings illustrating the measurements performed by the deceleration method;

FIGS. 3A and 3B are graphs illustrating the relationship between the fuel injection amount and indicated torque;

FIG. 4 is a graph illustrating periodic measurements of the engine friction torque and the results obtained;

FIG. 5A is a graph illustrating the measurement result on the engine friction torque obtained when light oil was used and when linseed oil was used, and

FIG. 5B is a table representing the specifications of the diesel engine used for measuring the engine friction torque;

FIG. 6 is a graph representing the relationship between the cylinder volume and cylinder pressure;

FIG. 7 is a graph representing the relationship between the cylinder volume and the difference in cylinder pressure between the compression stroke and expansion stroke;

FIG. 8 is a graph representing the relationship between the cylinder volume and cylinder pressure for the cycle during fuel injection and the cycle after the fuel supply has been stopped;

FIG. 9A, FIG. 9B and FIG. 9C are graphs representing the relationship between the difference in cylinder pressure between the compression stroke and expansion stroke and the cycle after the fuel cut-off, FIG. 9A is a graph in which the engine load is zero, FIG. 9B is a graph in which the engine load is 50%, and FIG. 9C is a graph in which the engine load is 100%;

FIG. 10 is a table illustrating the setting contents in the experimental design method; and

FIG. 11A, FIG. 11B and FIG. 11C are graphs representing the results obtained by implementing the experimental design method.

### DESCRIPTION OF THE EMBODIMENTS

Configuration of Engine E

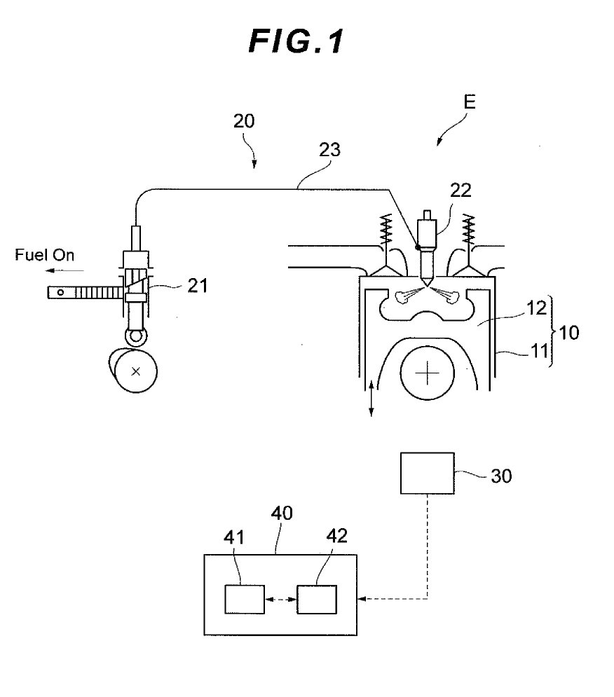

Embodiments of the present invention will be described hereinbelow with reference to the appended drawings. In the present embodiment, an example is explained in which the friction loss measurement method for an engine in accordance with the present invention is applied to a diesel engine E (referred to hereinbelow in a partially abbreviated form as “engine E”) depicted in FIG. 1. The inertia momentum measurement method for an engine and the friction loss measurement method for an engine in accordance with the present invention can be also applied, as will be described hereinbelow, to engines other than diesel engines.

Initially, the configuration of the engine E using the present invention will be explained with reference to FIG. 1. The engine E is configured of an engine main body 10 constituted by, for example, a cylinder 11 and a piston 12, and a fuel supplying device 20 which is driven by the engine main body 10. The engine E is provided with a crank angle detector 30 for friction loss measurements and a controller 40 that performs data analysis and processing and operation control of the engine E.

The fuel supplying device 20 is configured of a fuel supply pump 21 that is driven by the engine main body 10, a fuel injection nozzle 22 that is mounted on the engine main body 10 and injects fuel into the cylinder 11, and a fuel injection pipe 23 for feeding the fuel, which has been supplied by the fuel supply pump 21, to the fuel injection nozzle 22. The fuel supply pump 21 may be configured to be controlled electronically or mechanically.

The crank angle detector 30 detects the rotation angle of the crankshaft (output shaft) of the engine E and sends the detection signal corresponding to the detected rotation angle to the controller 40. The controller 40 is constituted by a CPU 41 performing computational processing and a memory 42 storing control information on the engine E. The CPU 41 of the controller 40 receives the signal (signal corresponding to the rotation angle of the crankshaft) from the crank angle detector 30, calculates the angular deceleration on the basis of the angular speed of the crankshaft and calculates the friction loss on the basis of this angular deceleration in the below-described manner.

Engine Friction Torque

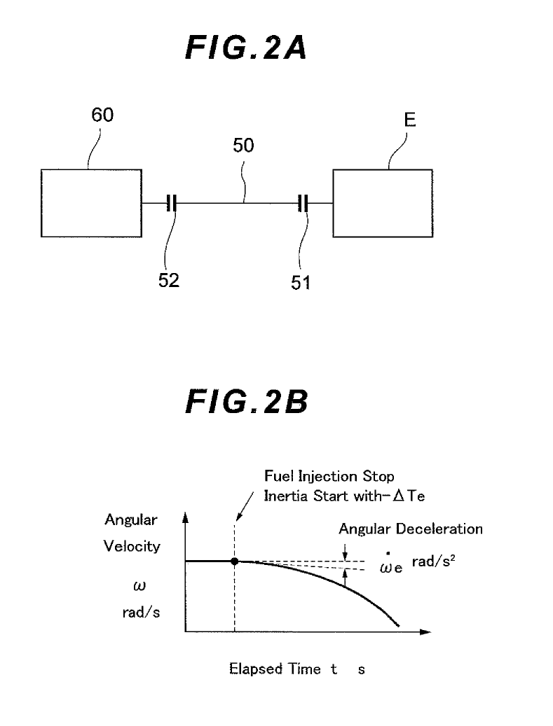

The engine E of such a configuration is often used as a power source for a working machine, or the like. For example, the configuration is used, as depicted in FIG. 2A, in which a power transmission system 50 is connected through a coupling 51 to the output shaft of the engine E, a working machine 60 is connected through a coupling 52 to the power transmission system 50, and the working machine 60 is rotationally driven through the power transmission system 50. When the engine E is driven by injecting the fuel into the cylinder 11, energy (power) generated by the combustion of the fuel is generated, and the working machine 60 is rotationally driven by this power through the power transmission system 50. The rotation resistance torque of the engine itself, which is generated, for example, by sliding resistance inside the engine E will be referred to hereinbelow as “engine friction torque Tf”, and the rotation resistance torque generated, for example, by sliding resistance in the power transmission system 50 and the working machine 60 will be refereed to hereinbelow as “driven-side friction torque T_{Load}”.

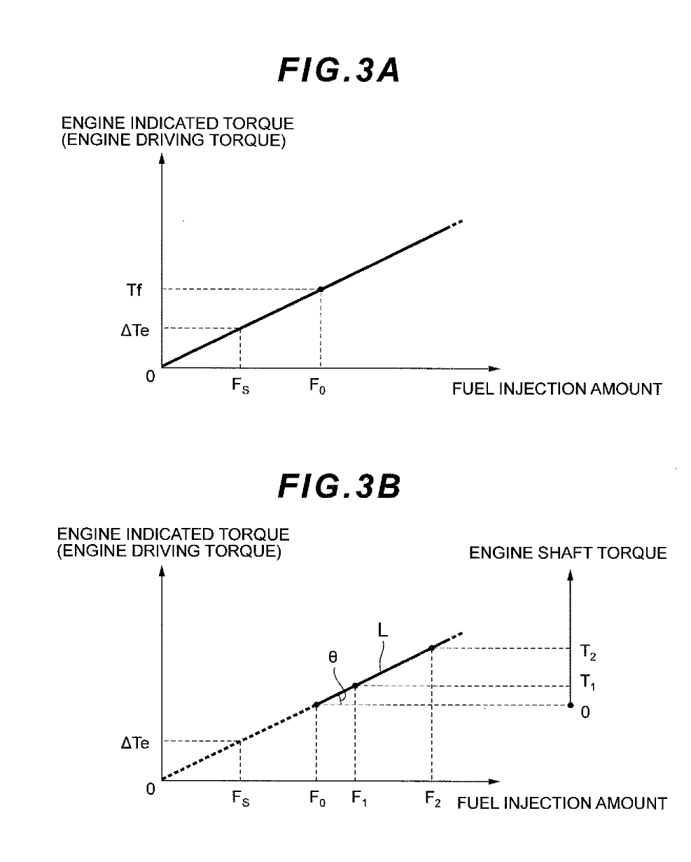

In a stable driving state in which the amount of air related to the supplied fuel is sufficient and the combustion is stable, the fuel injection amount (fuel supply amount) and engine power are typically found to be proportional to each other and no problem arises. Further, in the stable driving state, as depicted in FIG. 3A, the fuel injection amount and engine indicated torque (driving torque before it is reduced by friction inside the engine) are proportional to each other, and when fuel injection is completely cut off and the fuel injection amount (supplied energy) is zero, the engine output (engine indicated torque) is obviously also zero. In FIG. 3A, the engine indicated torque is plotted against the ordinate, and the fuel injection amount is plotted against the abscissa.

A state is herein assumed in which the engine E is driven independently, without connection to the power transmission system 50 (working machine 60). In this case, as depicted in FIG. 3A, where the engine indicated torque is in balance with the engine friction torque Tf at the fuel injection amount F₀, for example, when the fuel injection amount F₀ is reduced to a fuel injection amount F_{S}(<F₀), the engine indicated torque ΔTe immediately thereafter can be determined from Expression (4) below. This is because in a region with a small fuel injection amount F₀ at which the engine indicated torque is in balance with the engine friction torque Tf, or with the fuel injection amount F_{S} which is even less, where the engine revolution speed is the same, the engine indicated torque can be considered to be substantially proportional to the fuel injection amount. A program for calculating the engine driving torque (indicated torque) corresponding to the fuel injection amount by using Expression (4) below is stored in the memory 42 of the controller 40 depicted in FIG. 1.

ΔTe=Tf×F_{S}/F₀ (4)

The total inertia momentum of the entire system constituted by the engine E, the power transmission system 50, and the working machine 60 is determined hereinbelow, for example, by measuring the deceleration of the engine output shaft rotation occurring when the fuel injection amount is reduced from the engine stable driving state and using the engine driving torque ΔTe determined as described hereinabove. A method for determining the engine friction torque by using this total inertia momentum is also explained hereinbelow. The above-described approach can be said to be the same when the fuel injection amount is increased in the engine stable driving state.

Method for Calculating Engine Friction Torque

Explained hereinbelow is the case in which the abovementioned method in accordance with the present invention which is based on the above-described approach and uses the deceleration method is applied to the working machine 60, which is driven through the power transmission system 50 connected to the output shaft of the engine E, and the total inertia momentum It and total friction torque Tt (a total friction torque obtained by adding up the engine friction torque Tf and the driven-side friction torque T_{Load}, that is, Tt=Tf+T_{Load}) of the entire system constituted by the engine E, the power transmission system 50, and the working machine 60 are determined. The deceleration method, as referred to herein, is a method in which, as a general rule, the engine E is set to two deceleration states different from the steady operation state by performing predetermined fuel supply (fuel injection), the inertia momentum is determined on the basis of angular deceleration measured in each deceleration state, and the friction torque is determined on the basis of the inertia momentum. The friction loss or friction torque defined in the present embodiment has a broad meaning inclusive not only of mechanical loss, but also pumping loss in the intake and exhaust strokes.

In the present embodiment, the angular deceleration is measured in a deceleration state obtained as a result of deceleration caused by cutting off the fuel injection from the state in which the predetermined fuel supply (for example, the fuel injection amount F₀) is performed and the engine E is steadily operated to drive the working machine, and the deceleration state obtained as a result of deceleration caused by reducing the fuel injection amount to a small amount (for example, the fuel injection amount F_{S}), while performing fuel combustion, from the state in which the engine E is likewise steadily operated to drive the working machine. Initially, where the angular deceleration of the crankshaft in the deceleration state obtained as a result of deceleration caused by cutting off the fuel injection from the state in which the engine E is steadily operated to drive the working machine is taken as dω/dt, the relationship between the total inertia momentum It and the total friction torque Tt(=engine friction torque Tf+driven-side friction torque T_{Load}) is represented by Expression (5) below.

Tt=(Tf+T_{Load})=It×dω/dt (5)

Meanwhile, where the angular deceleration of the crankshaft in the deceleration state obtained as a result of deceleration caused by reducing the fuel injection amount to F_{S} from the state in which the engine E is steadily operated to drive the working machine is taken as dωe/dt, and the engine driving torque corresponding to the fuel injection amount F_{S} is taken as ΔTe, the relationship between the total inertia momentum It and the total friction torque Tt′ at this time(=engine friction torque Tf+driven-side friction torque T_{Load}−ΔTe) is represented by Expression (6) below. FIG. 2B is a graph illustrating the relationship between the angular deceleration and elapsed time at the time of such deceleration.

Tt′=(Tf+T_{Load}−ΔTe)=It×dωe/dt (6)

The total inertia momentum It can be determined according to Expression (7) below from Expressions (5) and (6).

It=−ΔTe/(dωe/dt−dω/dt) (7)

In Expression (7), the engine driving torque ΔTe is calculated by reading and executing the program represented by Expression (4) which has been stored in the memory 42. The angular deceleration dω/dt in Expression (5) and the angular deceleration dωe/dt in Expression (6) are calculated by the CPU 41 on the basis of the detection signals from the crank angle detector 30. Therefore, the total inertia momentum It can be determined from Expression (7). By substituting the total inertia momentum It which has thus been determined into Expression (5), it is possible to obtain the total friction torque Tt(=engine friction torque Tf+driven-side friction torque T_{Load}) at the time when the angular deceleration dω/dt has been measured, as described hereinabove.

In this case, both the engine friction torque Tf and the driven-side friction torque T_{Load} can change with time due to continuous operation, for example, due to the wear of parts such as bearings. However, when the engine E is new (no wear to bearings, or the like), the engine friction torque Tf corresponding to the predicted design specifications should be obtained. Therefore, the driven-side friction torque T_{Load} can be estimated in the following manner. In order to estimate the driven-side friction torque T_{Load}, initial performance data indicating the relationship between the fuel injection amount and engine revolution speed when the engine E is driven independently, that is, without connection to the power transmission system 50 (working machine 60), those performance data being obtained at the production time of the engine E, are stored in the memory 42 of the engine E. By measuring the revolution speed of the engine E at the time when the working machine 60 is driven by preforming the predetermined fuel supply (for example, fuel supply amount F₀), and referring to the initial performance data on the basis of the measured revolution speed, it is possible to determine the fuel injection amount F_{Z} at this engine revolution speed in the case in which the driven-side friction torque T_{Load} is zero (that is, when only the engine friction torque Tf acts). In this case, in the actual driving state, extra fuel injection corresponding to the driven-side friction torque T_{Load} is performed with respect to the case in which only the engine friction torque Tf acts, and a higher engine driving torque is output. Therefore, fuel injection amount F₀>fuel injection amount F_{Z}. By finding the difference between the fuel injection amount F₀ and the fuel injection amount F_{Z} and determining a torque (engine driving torque) corresponding to this difference (fuel injection amount) by referring to FIG. 3A, it is possible to estimate this torque (engine driving torque) as the driven-side friction torque T_{Load} at this time.

Here, since the total inertia momentum It is constant as long as the device configuration of the engine, the power transmission system 50, and the working machine 60 is not changed, when the total friction torque Tt(=engine friction torque Tf+driven-side friction torque T_{Load}) is measured again in the device configuration, the total inertia momentum It determined in the above-described manner can be used as is to determine the torque from Expression (5). For example, the predetermined fuel supply is performed to operate the engine E and drive the working machine 60, the fuel supply is cut off in this state, and the angular deceleration of the crankshaft at this time is measured. The total friction torque Tt can be determined from the angular deceleration dω/dt which is measured at this time and the total inertia momentum It which has already been obtained. In this case, when it can be assumed that the driven-side friction torque T_{Load}, which has been found in the above-described manner, does not change with time, the engine friction torque Tf can be obtained by subtracting the driven-side friction torque T_{Load} from the total friction torque Tt. Further, instead of calculating the angular decelerations dωe/dt and dω/dt on the basis of the state at the time of switching to the deceleration state, the calculations may be performed on the basis of the state in the course of deceleration after switching to the deceleration state. It is also possible to calculate the angular deceleration at a plurality of points of time after switching to the deceleration state and find an average value.

Incidentally, with the method for measuring the friction torque (total friction torque) by using a dynamometer, the engine is transported to the measurement facility provided with the dynamometer corresponding to the engine, which is the measurement object, and the measurements are conducted by connecting the engine to the dynamometer. Therefore, it cannot be said that measurements are possible everywhere, provided that the measurement facility with the dynamometer is present, and the measurement location and measurement conditions are strictly limited. By contrast, with the inertia momentum measurement method for an engine and the friction loss measurement method for an engine in accordance with the present invention, the deceleration state is obtained by controlling fuel injection, thereby making it possible to determine the total inertia momentum It and total friction torque without using a dynamometer (without transporting the engine, which is the measurement object, to the measurement facility equipped with the dynamometer). For this reason, for example, when the total friction torque of the engine installed on a ship is measured, the total friction torque can be measured while the engine is still installed on the ship. Further, since data collection for measuring the total friction torque can be performed by producing a deceleration state only for a short period of time, such that the usual operation is not inhibited, the total friction torque can be measured, as appropriate and necessary, without stopping the engine, which is the measurement object, that is, during the usual operation of the engine. The problem associated with labor-intensive transportation of the engine when the total friction torque is measured using a dynamometer and the problem of restricted measurement timing become particularly acute in the case of large engines which are installed on ships or power-generating facilities and operated continuously over a long period once the operation is started, but where the present invention is applied to such engines, the total friction torque can be measured at all times while resolving the abovementioned problems.

Application Example of Friction Loss Measurement Method

An application example of the friction loss measurement method for an engine in accordance with the present invention is explained hereinbelow.

In the application example explained hereinbelow, the total friction torque Tt is measured periodically according to the present invention with respect to a continuously operating engine, and temporal degradation of engine performance and the occurrence of, for example, engine failures are estimated on the basis of the transition in the measurement results. Where the total inertia momentum It is determined once in the above-described manner, the total friction torque Tt(=Tf+T_{Load}) can be determined at any time from Expression (5) by cutting off the fuel from the steady operation state and measuring the angular deceleration dω/dt of the output rotation. The temporal degradation of engine performance and the occurrence of engine failures can thus be estimated by periodically (for example, every several months) measuring the total friction torque Tt and observing changes therein. Since temporal changes in the total friction torque Tt are observed, those changes are caused not only by temporal changes in the engine friction torque Tf, but also by temporal changes in the driven-side friction torque T_{Load}. However, temporal changes in the engine friction torque Tf are generally greater than temporal changes in the friction torque (driven-side friction torque T_{Load}) of the power transmission system 50 and the working machine 60, and engine performance degradation and failures can be estimated by observing temporal changes in the total friction torque Tt. In this case, where the driven-side friction torque T_{Load} is measured when the engine E is a new product, as mentioned hereinabove, it is possible to find the engine friction torque Tf by subtracting the driven-side friction torque T_{Load} from the total friction torque Tt and observe temporal changes therein.

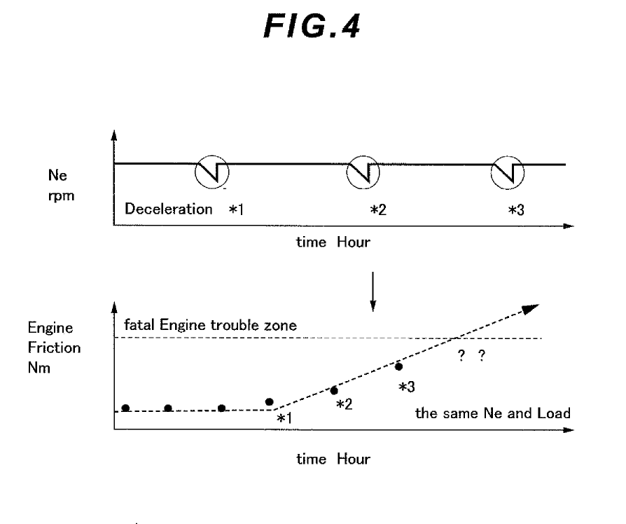

FIG. 4 shows an example in which the engine friction torque Tf is measured in the above-described manner. In this case, the total friction torque Tt is determined at a measurement timing *1, and the engine friction torque Tf is calculated. The engine friction torque Tf is then calculated by determining the total friction torque Tt at a measurement timing *2 at a predetermined time from the measurement timing *1 and at a measurement timing *3 which is at a predetermined time therefrom. Temporal changes in the engine friction torque Tf (or total friction torque Tt) are thus determined.

The measurements at the measurement timings *1 to *3 are performed in states with the same engine revolution speed and load. As a result, substantially the same total friction torque should be measured at all measurement timings, provided that no failure has occurred in the engine. However, where engine performance degradation or failure (for example, damage of a bearing) occurs, the mechanical loss increases, and therefore the engine friction torque Tf (and total friction torque Tt) increases. FIG. 4 (lower part) illustrates an example in which the engine friction torque Tf (and total friction torque Tt) increases with the passage of time. When the engine friction torque Tf (or the total friction torque Tt) exceeds a predetermined threshold (the threshold for estimating the occurrence of engine performance degradation and failure; in the figure, the value of the level indicated as a fatal engine trouble zone), it can be estimated that the engine performance degradation is equal to or above the allowed limit, or that a failure or a sign of failure has appeared. Since the engine performance degradation and failure and the like can thus be detected at an early stage and, if necessary, the determination can be made to stop and repair the engine, the engine can be reliably prevented from a fatal failure.

Method 1 for Estimating Relative Amount of Combustion Deposits

In the operation of not only diesel engines, but also gasoline engines and gas engines, pistons are moved reciprocatingly by the combustion of fuel inside the cylinders. Where the engine is operated in such a manner for a long time, scab-like combustion deposits can be formed on the surfaces forming the fuel injection region (more specifically, the lower surface of the cylinder head, the upper surface of the piston, and the recess (combustion chamber) surface provided at the piston top). Where the combustion deposits are deposited, they can prevent the engine from operating stably. Therefore, it is important to determine the amount of combustion deposits (relative amount of combustion deposits). Accordingly, a method for estimating the relative amount of combustion deposits will be described hereinbelow. Before explaining this estimation method, the background thereof will be described.

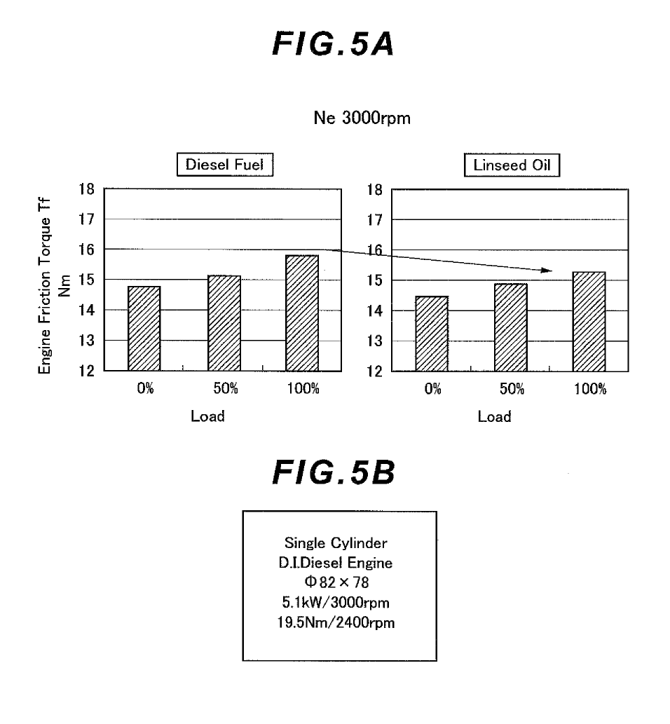

A diesel engine that can be also adapted to vegetable oils (for example, linseed oil), which are carbon neutral, has been developed. Vegetable oils are generally higher in viscosity than light oils, but where the test diesel engine is the same, apparently there is no intrinsic difference in the engine friction torque in a state without fuel injection between the case in which linseed oil is used and the case in which light oil is used. To verify this, the engine friction torque was measured in the case in which linseed oil was used and the case in which a light oil was used. The results obtained are depicted in FIG. 5A. The measurement results relating to the engine friction torque in the case in which light oil was used are shown for each load in the graph on the left side in FIG. 5A, and the measurement results relating to the engine friction torque in the case in which linseed oil was used are shown for each load in the graph on the right side in FIG. 5A. In the measurements, the engine friction torque was determined by cutting off the injection of fuel from the state in which the engine was driven at a predetermined revolution speed (in this case, 3000 rpm) both in the case in which linseed oil was used and in the case in which light oil was used. Comparing the left and right graphs in FIG. 5A, it is clear that the engine friction torque was lower in the case in which linseed oil was used than in the case in which light oil was used under any load conditions (0%, 50%, 100%). The specifications of the verified test diesel engine are depicted in FIG. 5B.

The reason why the results depicted in FIG. 5A were obtained is considered hereinbelow. Both with linseed oil and with light oil, an effect (referred to hereinbelow as “residual combustion”) apparently occurs in which part of the fuel injected into the cylinder in a cycle before the fuel injection is cut off remains unburned in a state of adhesion to the cylinder head or piston even in the cycle after the fuel injection cut-off, and this fuel (referred to hereinbelow as “residual fuel”) is burned in the cycle after the fuel injection has been cut off. As a result of such residual combustion, a work corresponding thereto is performed and the angular deceleration is decreased. For this reason, the engine friction torque which is less than the actual engine friction torque is measured.

Since linseed oil is higher in viscosity and evaporation temperature than light oil, linseed oil easier than light oil remains on the cylinder head and piston. This is apparently why the residual combustion occurring with linseed oil is stronger than that occurring with light oil. Because of such strong residual combustion, a work corresponding thereto is performed, the angular deceleration is decreased, and the engine friction torque lower than that in the case of light oil is measured. In other words, because of a difference in the intensity of residual combustion which is caused by the viscosity and evaporation temperature of fuel, the engine friction torque obtained is lower in the case of linseed oil than in the case of light oil, as depicted in FIG. 5A.

When combustion deposits are deposited on the cylinder head and piston, part of the injected fuel adheres to the cylinder head and piston and permeates into the combustion deposits. Residual combustion is apparently also caused by such permeated residual fuel. In other words, when a relatively large amount of combustion deposits is present, the amount of residual fuel permeating into the combustion deposits increases correspondingly to the deposited amount of the combustion deposits. As a result, residual combustion with an intensity corresponding to the deposited amount of combustion deposits is induced. This is apparently why the calculated engine friction torque is less than the actual engine friction torque by the quantity of work performed by the residual combustion with an intensity corresponding to the amount of combustion deposits.

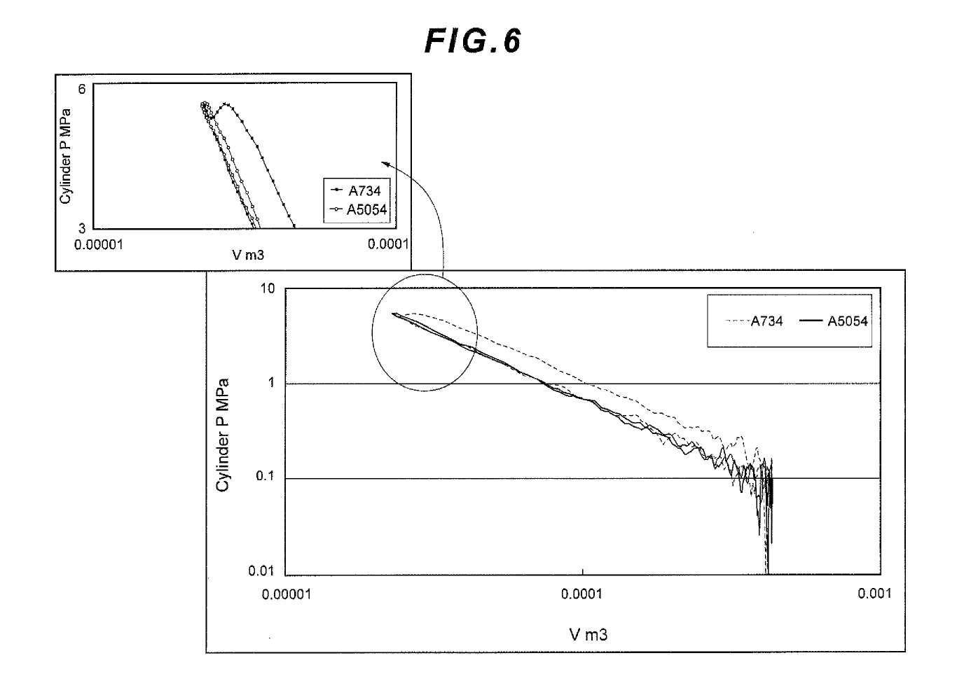

A method for estimating the relative amount of combustion deposits will be explained hereinbelow with reference to FIGS. 6 to 9. In FIG. 6, the relationship between the cylinder volume and cylinder pressure is shown in a graphic form with respect to each cycle when fuel injection is performed and when fuel injection has been cut off. The graph obtained when fuel injection is performed is plotted by connecting with a dot line the points actually measured for each 1°, and the graph obtained when fuel injection has been cut off is plotted by connecting with a narrow solid line the points actually measured for each 1°. Where fuel injection is cut off, no work is performed by fuel combustion. Therefore, when the relationship between the cylinder volume and cylinder pressure is depicted, a graph is obtained in which the cylinder pressure in the compression stroke overlaps that in the expansion stroke. However, actually, where a high-pressure portion (close to the top dead center) in the solid line in FIG. 6 is of interest, a graph is obtained in which the expansion stroke is slightly shifted to the high-pressure side with respect to the compression stroke, even when fuel injection has been cut off. This shift of the expansion stroke to the high-pressure side is apparently caused by the residual combustion occurring due to increase in cylinder temperature close to the top dead center which is caused by the compression stroke.

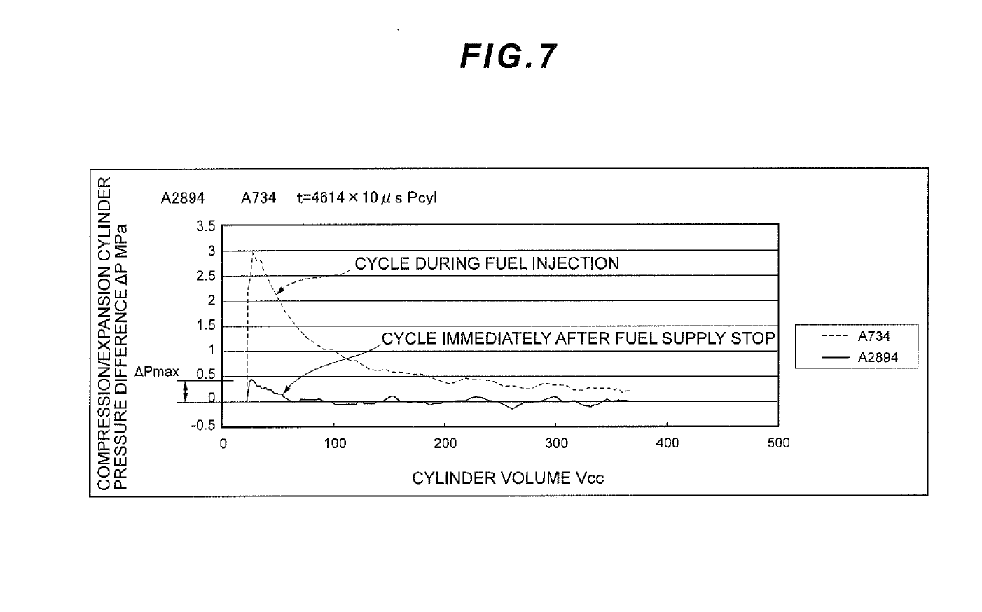

In this case, where combustion deposits are present, part of the injected fuel adheres to the cylinder head and piston and also permeates into the combustion deposits, and since it is clear that the amount of fuel permeating into the combustion deposits increases correspondingly to the deposited amount of combustion deposits, it can be assumed that residual combustion occurs with an intensity corresponding to the deposited amount of combustion deposits. The intensity of the residual combustion which thus occurs also corresponds, as indicated hereinabove, to the difference in cylinder pressure between the compression stroke and expansion stroke in FIG. 6. Therefore, the relative amount of combustion deposits can be estimated in the below-described manner on the basis on the difference in cylinder pressure between the compression stroke and expansion stoke. More specifically, the difference ΔP in cylinder pressure between the compression stroke and expansion stoke at each cylinder volume is calculated with respect to each cycle after the fuel injection has been cut off, and the maximum value ΔPmax of this cylinder pressure difference is determined. In FIG. 7, the results obtained in determining the cylinder pressure difference ΔP and the maximum value ΔPmax are shown with a solid line for a cycle immediately after the fuel injection has been cut off. As follows from the figure, ΔPmax is determined as a value close to the top dead center, but this value corresponds to the intensity (deposited amount of combustion deposits) of residual combustion. In FIG. 7, the results obtained in calculating the cylinder pressure difference ΔP at each cylinder volume are additionally shown for reference with a dot line for cycles during the fuel injection.

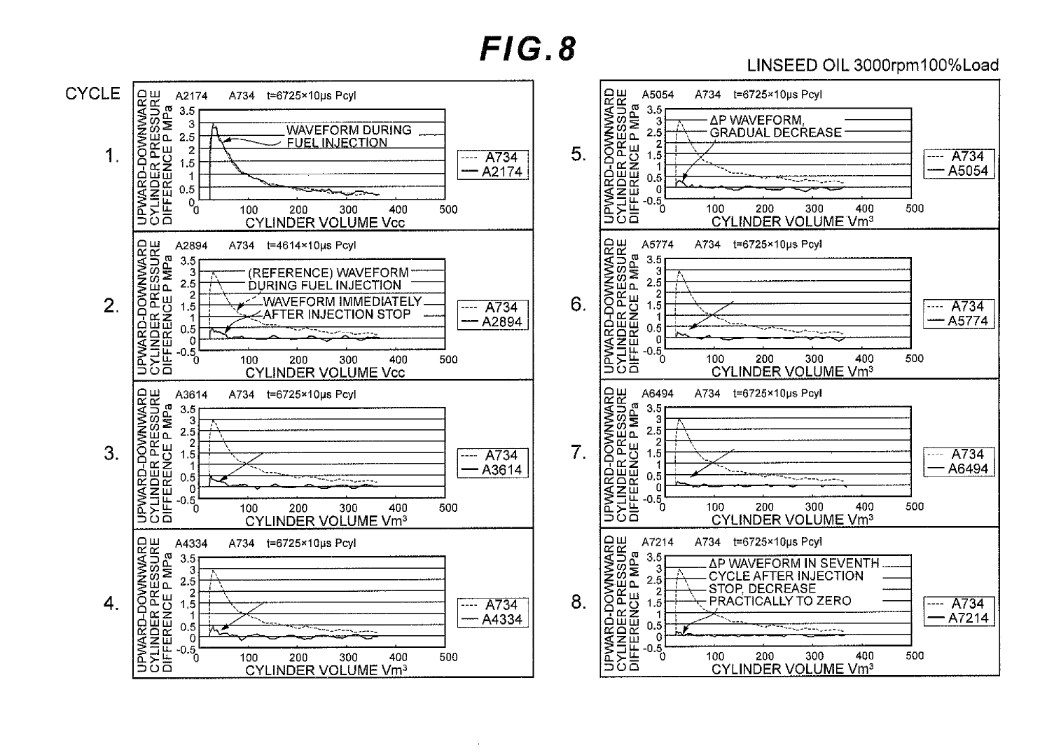

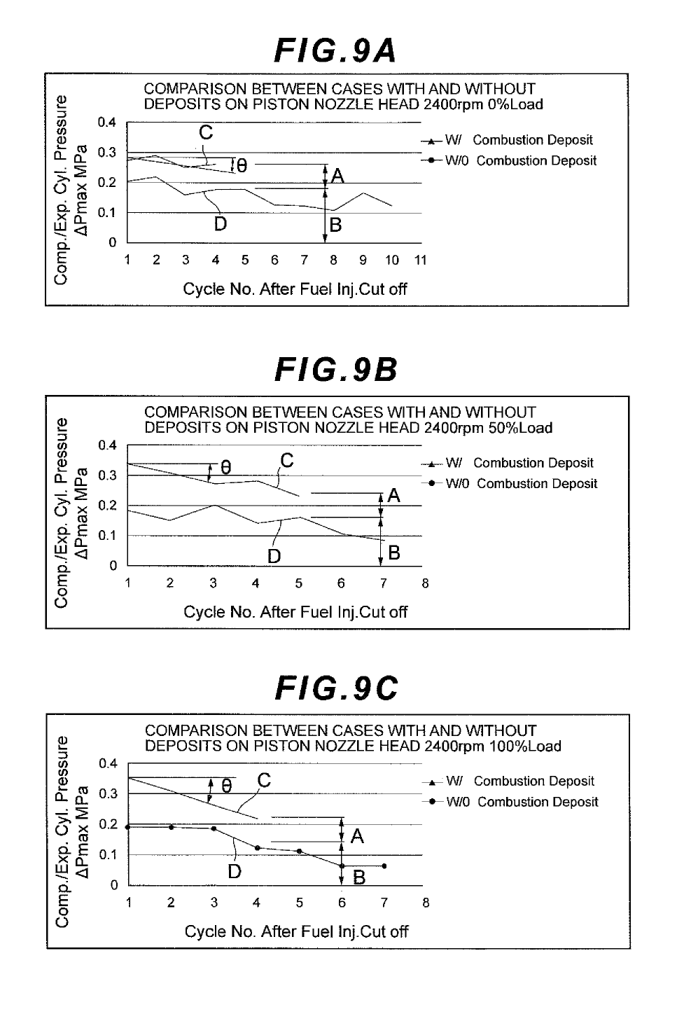

In FIG. 8, the cylinder pressure difference ΔP at each cylinder volume is graphically shown with a solid line for seven cycles (cycles 2 to 8 depicted in FIG. 8) after the fuel injection has been stopped. The values indicated by those graphs correspond to the amount of combustion deposits, and it is clear that the cylinder pressure difference ΔP and ΔPmax decrease and approach zero with the transition from cycle 2 to cycle 8. This is because the combustion deposits are gradually burned and removed and the residual combustion is weakened by the repetition of compression and expansion cycles involving no fuel injection. In cycle 1 in FIG. 8, the results relating to a cycle during fuel injection are shown for reference.

Where the engine is disassembled and cleaned and the combustion deposits are removed, it is possible to determine the cylinder pressure difference ΔP and ΔPmax which are unaffected by the combustion deposits. Therefore, the relative amount of combustion deposits can be estimated by comparing ΔPmax determined by the method illustrated by FIG. 8 with respect to an engine which has been operated over a long time and in which combustion deposits are assumed to be deposited with ΔPmax determined by the method illustrated by FIG. 8 with respect to an engine immediately after disassembling and cleaning in which no combustion deposits are present. More specifically, as depicted in FIGS. 9A to 9C, the estimation can be performed by comparing ΔPmax (characteristic line C) of each cycle after the fuel injection has been cut off with ΔPmax (characteristic line D) determined immediately after disassembling and cleaning. The graphs in FIGS. 9A to 9C are presented for each load state (0%, 50%, and 100%). In each of FIGS. 9A to 9C, the values of the characteristic line C are above the characteristic line D (immediately after disassembling and cleaning), and the difference between the characteristic line D and the characteristic line C (difference A in ΔPmax) corresponds to the relative amount of combustion deposits. Meanwhile, the characteristic line D in FIGS. 9A to 9C represents ΔPmax corresponding to the residual combustion occurring even without the combustion deposits, that is, to the residual fuel which has directly adhered to the cylinder head and piston and remained thereon. For this reason, the relative amount of combustion deposits can be determined on the basis of the difference A.

It follows from the above, that by cutting off the fuel injection, it is possible to collect data for measuring the engine friction torque by the deceleration method and determine the relative amount of combustion deposits on the basis of the cylinder pressure difference ΔP and ΔPmax which are measured at this time. Since such a fuel injection cut-off causes fluctuations in the engine output torque, it can inhibit the steady operation of the engine. Accordingly, for example, where fuel injection is cut off for groups of cylinders in the case of a multicylinder engine to measure the internal pressure, the relative amount of combustion deposits can be determined while inhibiting the effect on steady operation.

Method 2 for Estimating Relative Amount of Combustion Deposits

Explained hereinabove is the method for estimating the relative amount of combustion deposits by cutting off the fuel injection, but since torque fluctuations are caused by the fuel injection cut-off in this method, as mentioned hereinabove, steady operation of the engine can be inhibited. Explained hereinbelow is a method by which the relative amount of combustion deposits can be estimated, without producing a significant effect on steady operation, by suppressing torque fluctuations in the engine.

When the residual combustion was further investigated, it was understood that the effect occurs in a range of about 10° in the vicinity of the top dead center regardless of the presence of fuel injection. However, since fuel injection is usually performed close to the top dead center, the residual combustion and fuel injection occur practically simultaneously close to the top dead center. As a result, the cylinder pressure difference ΔP caused by residual combustion is difficult to distinguish from the cylinder pressure difference ΔP caused by combustion of the injected fuel. Accordingly, it was considered that the fuel injection timing was delayed. Thus, the combustion of the injection fuel can be started after the residual combustion has occurred close to the top dead center, and the cylinder pressure difference ΔP caused by residual combustion can be distinguished from the cylinder pressure difference ΔP caused by combustion of the injected fuel. Even if the fuel injection timing is delayed, since significant torque fluctuations do not occur, the relative amount of combustion deposits can be estimated without producing a significant effect on steady operation. Where the estimation of the relative amount of combustion deposits is performed without measuring the engine friction torque by the deceleration method, both the estimation by the fuel injection cut-off and the estimation by delaying the fuel injection timing are possible.

Instead of using the method for estimating the relative amount of combustion deposits on the basis of the cylinder pressure difference ΔP (ΔPmax), it is also possible to measure periodically the engine friction torque and estimate the relative amount of combustion deposits on the basis of changes in the measurement results. For example, when the engine friction torque decreases with the passage of time, the deposited amount of combustion deposits increases and the amount of residual fuel permeating thereinto also increases. This apparently results in the increased intensity of residual combustion and decreased engine friction torque. Therefore, in this case, it can be estimated that the relative amount of combustion deposits increases.

Method for Removing Combustion Deposits

Where the deposited amount of combustion deposits is estimated to be comparatively large as a result of estimating the relative amount of combustion deposits in the above-described manner, it is desirable that the combustion deposits be removed. A method for disassembling and cleaning the engine can be considered in this case, but with this method, steady operation of the engine is stopped while the disassembling and cleaning are performed. For this reason, this method is often difficult to use. A method for removing combustion deposits without disassembling and cleaning the engine is described hereinbelow.

The graphs represented by solid lines in cycles 2 to 8 in FIG. 8 show the cylinder pressure difference ΔP at each cylinder volume for 7 cycles after the fuel injection has been stopped, but where they are orderly viewed from cycle 2 according to time sequence, it can be seen that the cylinder pressure difference ΔP and ΔPmax decrease gradually and approach zero as a result of repeating compression and expansion strokes without performing fuel injection. This result means that the residual combustion is gradually weakened. Therefore, combustion deposits apparently can be burned and removed by repeating the cycles with fuel injection cut-off.

Meanwhile, fuel deposits can be also burned and removed by starting the combustion of the injected fuel after the combustion deposits have burned and residual combustion has occurred close to the top dead center by delaying the fuel injection timing instead of cutting the fuel injection. By so delaying the fuel injection timing, it is possible to burn and remove the combustion deposits close to the top dead center where comparatively high temperature and pressure are attained.

As described hereinabove, where cycles in which fuel injection cut-off or fuel injection timing delay have been implemented are continued, the combustion deposits can be removed in a simple manner, without disassembling and cleaning the engine.

Where fuel injection is thus cut off, fluctuations occur in the output torque of the engine. Therefore, steady operation of the engine can be sometimes inhibited. Accordingly, for example, in the case of a multicylinder engine, the combustion deposits can be removed, while suppressing output torque fluctuations and producing practically no effect on steady operation, by implementing the fuel injection cut-off with respect to some of the cylinders. Since toque fluctuations are less in the case of fuel injection timing delay than when the fuel injection is cut off, the combustion deposits in all of the cylinders can be also removed by implementing the fuel injection timing delay simultaneously with respect to all of the cylinders, while steadily operating the engine.

Increase in Removal Efficiency of Combustion Deposits

A method for removing combustion deposits more effectively when removing the combustion deposits in the above-described manner is described hereinbelow.

When the fuel injection cut-off or fuel injection timing delay is implemented in the above-described manner, the combustion of the combustion deposits is enhanced by a high cylinder temperature close to the top dead center and the combustion deposits apparently can be removed with good efficiency. Accordingly, in the case of an engine equipped with a supercharger and an intercooler, the combustion temperature can be increased and the combustion deposits can be burned with good efficiency by supplying high-temperature intake air compressed by the supercharger into the cylinder, without allowing the intake air to pass through the intercooler, that is, while the intake air is still at a high temperature. As another method, it is possible to take out part of the post-combustion high-temperature exhaust gas and supply it again into the cylinder (this is also referred to as EGR), which can also result in the increased combustion temperature and efficient combustion of the combustion deposits.

In the above-described embodiment, the case is considered in which the friction loss measurement method is applied to a diesel engine of a natural ignition type by way of example. However, the application of the friction loss measurement method explained in the above-described embodiment is not limited to a diesel engine, and this method can be also applied, for example, to a gas engine or gasoline engine of a spark ignition type. When the above-described friction loss measurement method is applied to an engine of a spark ignition type, a deceleration state can be obtained by cutting off the fuel injection or stopping the spark ignition. Further, when the above-described method for estimating the relative amount of combustion deposits and method for removing the combustion deposits are applied to an engine of a spark ignition type, the ignition timing may be delayed instead of cutting off the fuel supply. In particular, for example, in a gas engine, when spark ignition is stopped, the unburned gas flows through the cylinder into the exhaust system and there is a risk of flue explosion caused by the high-temperature exhaust gas. This risk can be reduced by using a method for delaying the ignition timing.

However, when gasoline engines and gas engines in which pre-ignition occurs were examined, it was found that the combustion deposits accumulated on the cylinder head and piston came off, thereby creating an ignition source and causing pre-ignition. Accordingly, by applying the above-described method for estimating the relative amount of combustion deposits to the gasoline engines and gas engines and periodically determining the relative amount of combustion deposits, it is possible to implement the above-described removal of combustion deposits prior to the occurrence of pre-ignition and prevent such an occurrence.

In the above-described embodiment, an example is explained in which the total inertia momentum It is calculated on the basis of a state in which fuel injection is cut off from the steady operation state of the engine and a state in which fuel is injected in the fuel injection amount F_{S} also from the steady operation state of the engine. However, this is merely an example. In short, the total inertia momentum It may be calculated by executing in two patterns the fuel injection such that the engine assumes a deceleration state during steady operation, deriving equations for determining the total friction torque Tt of the engine for each pattern, and solving those equations as a set. Thus, the total friction torque Tt of the engine can be represented by Expression (8) below by measuring the angular deceleration dωe₁/dt of the engine output rotation when the fuel supply amount is reduced in the steady operation state of the engine to a first fuel supply amount which is less than the fuel supply amount in this state. Here, ΔTe₁ is the engine driving torque corresponding to the first fuel supply amount.

Tt=Tf+T_{Load}−ΔTe₁=It×dωe₁/dt (8)

The total friction torque Tt of the engine is then represented by Expression (9) below by measuring the angular deceleration dωe₂/dt of the engine output rotation when the fuel supply amount is reduced in the steady operation state of the engine to a second fuel supply amount (fuel supply amount different from the first fuel supply amount) which is less than the fuel supply amount in this state. Here, ΔTe₂ is the engine driving torque corresponding to the second fuel supply amount.

Tt=Tf+T_{Load}−ΔTe₂=It×dωe₂/dt (9)

By combining Expressions (8) and (9) as a set and solving them with respect to the total inertia momentum It, it is possible to represent the total inertia momentum It by Expression (10) below. Therefore, the total inertia momentum It can be determined on the basis of Expression (10) below.

It=(−ΔTe₂+ΔTe₁)/(dωe₂/dt−dωe₁/dt) (10)

In the method explained by way of example in the above-described embodiment, a small engine driving torque ΔTe in a deceleration state is calculated on the basis of a ratio of the engine friction torque with the fuel injection amount F₀ in a balanced idling state, as indicated in Expression (4), but the small engine driving torque ΔTe in a deceleration state may be instead calculated by a method illustrated by FIG. 3B. Thus, with this method, the engine shaft torques (T₁ and T₂) are measured when the fuel is injected in an amount larger than the fuel injection amount F₀ (a fuel supply amount F₁ and a fuel supply amount F₂ which generate an engine driving torque larger than the engine friction torque), and the small engine driving torque is calculated by Expression (11) below by using an inclination θ of a straight line L obtained from the measurement results.

ΔTe=θ×F_{S}=(T₂−T₁)/(F₂−F₁)×F_{S} (11)

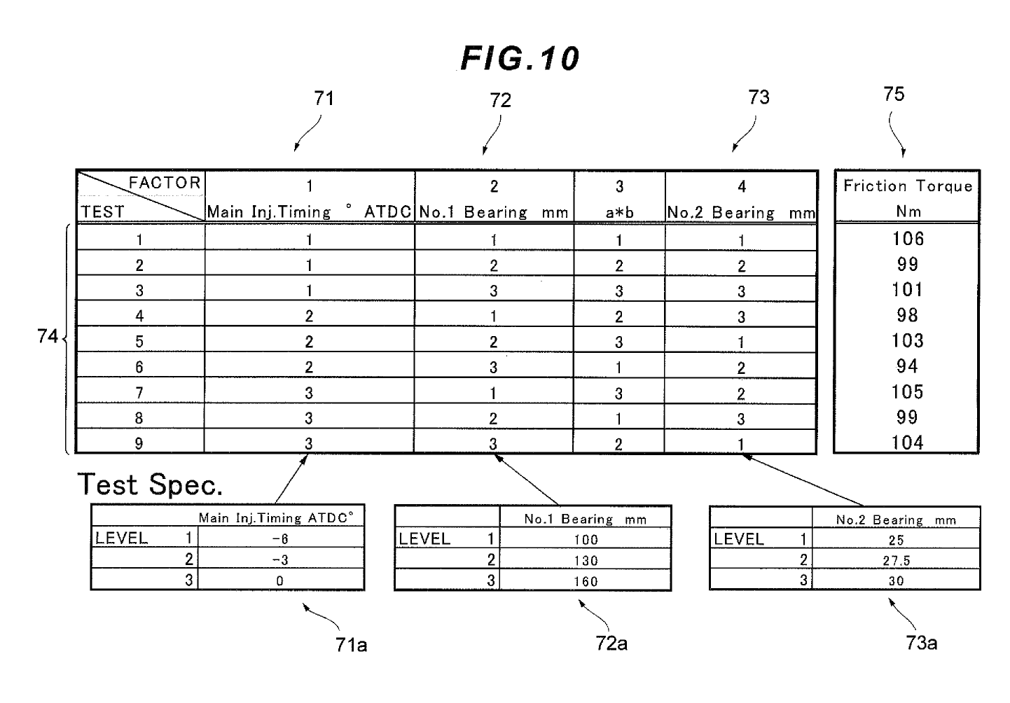

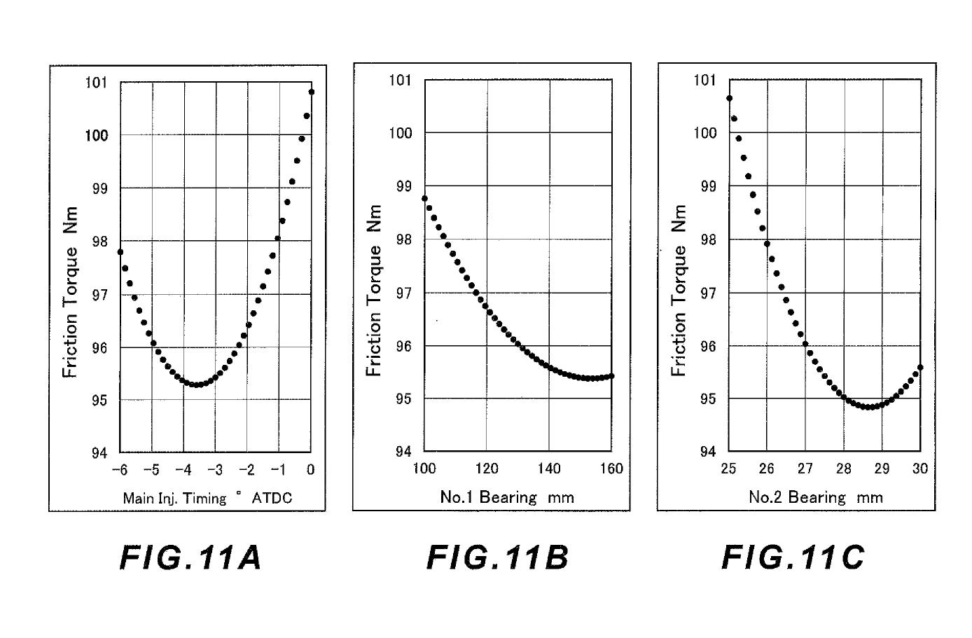

In the above-described embodiment, a method is explained for measuring the total friction torque Tt=(Tf+T_{Load}) obtained by adding up the engine friction torque Tf and the driven-side friction toque T_{Load}, but with this method, it is difficult to understand the degree to which the friction torque is affected by each constituted member affecting the friction torque, such as a bearing. Accordingly, the degree of effect produced by each constituent component on the friction torque can be estimated by measuring the friction torque by the deceleration method with respect to each of the set contents (tests 1 to 9) depicted in FIG. 10 (referred to hereinbelow as an “experimental design method”) and plotting the measurement results as graphs, as depicted in FIGS. 11A to 11C.

More specifically, in FIG. 10, three factors which change the settings (factors that can affect the friction torque) are assumed, FACTOR 1 being the fuel ignition timing (vertical column 71), FACTOR 2 being the width of the first bearing (vertical column 72), and FACTOR 4 being the width of the second bearing (vertical column 73). The fuel injection timing, which is the FACTOR 1, can be set to three levels, namely, −6°, −3°, and 0°, with respect to the ATDC, as indicated in Table 71a, and the corresponding levels are represented by 1, 2, and 3 in the vertical column 71. The width of the first bearing can be set to three levels, namely, 100 mm, 130 mm, and 160 mm, as indicated in Table 72a (actually, the first bearing of each width is prepared and replaced as necessary), and the corresponding levels are represented by 1, 2, and 3 in the vertical column 72. The width of the second bearing can be set to three levels, namely, 25 mm, 27.5 mm, and 30 mm, as indicated in Table 73a (actually, the second bearing of each width is prepared and replaced as necessary), and the corresponding levels are represented by 1, 2, and 3 in the vertical column 73. The combinations of the levels of the factors are shown as TESTS 1 to 9 in the vertical column 74, and the results of determining the friction torque by the deceleration method under the set conditions indicated for each test are shown in the vertical column 75. For example, TEST 1 indicates that the friction torque of 106 Nm is measured by the deceleration method under the following set conditions: FACTOR 1 is at the level 1 (the fuel ignition timing is −6° with respect to the ATDC), FACTOR 2 is at the level 1 (the width of the first bearing is 100 mm), and FACTOR 4 is at the level 1 (the width of the second bearing is 25 mm).

An empirical formula was derived on the basis of the results depicted in FIG. 10, and FIGS. 11A to 11C graphically represent the results depicted in FIG. 10 on the basis of the empirical formula. FIG. 11A graphically represents the relationship between the friction torque and the fuel injection timing. This graph indicates that the friction state immediately before the deceleration in the deceleration method differs depending on the fuel injection timing, and this difference affects the friction torque. FIG. 11B graphically represents the relationship between the friction torque and the width of the first bearing. This graph indicates that the friction torque is stable within the range of the first bearing width of 150 mm to 160 mm, but the friction torque tends to increase with the decrease in width in a range below 150 mm. FIG. 11C graphically represents the relationship between the friction torque and the width of the second bearing. This graph indicates that the friction torque is at a minimum when the width of the second bearing is close to 28.5 mm and that the friction torque tends to increase when the width is above or below this value.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An inertia momentum measurement method for an engine, which is a method for measuring a total inertia momentum It of an engine including a driving system of a drive device which is driven by the engine in a state in which the drive device is connected to an output shaft of the engine,
the method comprising:
a first step for measuring a deceleration dωe₁/dt of engine output rotation when a fuel supply amount to the engine is reduced to a first fuel supply amount, which is less than a predetermined fuel supply amount, from a state in which the predetermined fuel supply is performed to the engine and the engine is steadily operated to drive the drive device;
a second step for measuring a deceleration dωe₂/dt of engine output rotation when a fuel supply amount to the engine is reduced to a second fuel supply amount, which is less than the predetermined fuel supply amount, from a state in which the predetermined fuel supply is performed to the engine and the engine is steadily operated in the same manner as in the steady operation to drive the drive device; and
a third step for determining the total inertia momentum It on the basis of the following Expression (1):
It=(−ΔTe₂+ΔTe₁)/(dωe/dt−dωe₁/dt) (1)
where
ΔTe₁ is an engine driving torque of the engine corresponding to the first fuel supply amount; and
ΔTe₂ is an engine driving torque of the engine corresponding to the second fuel supply amount.

2. The inertia momentum measurement method for an engine according to claim 1, wherein the engine driving torque ΔTe₁ and the engine driving torque ΔTe₂ are determined on the basis of a proportional relationship between the fuel supply amount to the engine and the engine driving torque.

3. The inertia momentum measurement method for an engine according to claim 1, wherein in the first step, the deceleration dωe₁/dt of the engine output rotation is measured by taking the first fuel supply amount as zero and the total inertia momentum It is determined on the basis of the following Expression (2):
It=−ΔTe₂/(dωe₂/dt−dωe₁/dt) (2).

4. A friction loss measurement method for an engine, the method comprising:
a fourth step for determining the total inertia momentum It by the method according to claim 1;
a fifth step for measuring a deceleration dω/dt of engine output rotation when a fuel supply amount to the engine is cut off from a state in which the engine is operated to drive the drive device; and
a sixth step for determining a total friction torque Tt including the drive device on the basis of the following Expression (3):
Tt=It×dω/dt (3).
